(19) United States
(12) Patent Application Publication
(10) Pub. No.: US 2026/0127239 A1
(43) Pub. Date: May 7, 2026

(54) SYSTEM AND METHOD FOR MODIFYING A DATA RECORD MAINTAINED BY A THIRD PARTY SERVER

(71) Applicant: The Toronto-Dominion Bank, Toronto (CA)

(72) Inventors: Amanda VAZANTE, Oakville (CA); Romy MOGHAIZEL, Toronto (CA)

(73) Assignee: The Toronto-Dominion Bank, Toronto (CA)

(21) Appl. No.: 18/934,535

(22) Filed: Nov. 1, 2024

(51) Int. Cl. G06F 16/957; G06F 16/958

(52) U.S. Cl. CPC G06F 16/9577; G06F 16/958

(57) ABSTRACT

A server computer system comprises at least one processor; a communications module coupled to the at least one processor; and a memory coupled to the at least one processor, the memory storing instructions that, when executed, configure the at least one processor to send, via the communications module to a computing device, a signal that causes the computing device to display a selectable interface element for requesting modification to a data record maintained by a third party server; receive, via the communications module from the computing device, a signal indicating selection of the selectable interface element; identify at least one alternative modification based at least on the requested modification; and send, via the communications module to the computing device, a signal causing the computing device to display a recommendation for the at least one alternative modification. A machine learning module trained to identify the one alternative modification may be engaged.

### TECHNICAL FIELD

The present application relates to systems and methods for modifying a data record maintained by a third party server.

### BACKGROUND

Modifying data records requires use of computing resources. Resource consumption may increase depending on factors such as the complexity of the modification, the size of the data, and the system architecture.

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2A is a high-level schematic diagram of an example computing device;

FIG. 2B is a schematic block diagram showing a simplified organization of software components stored in memory of the example computing device of FIG. 2A;

FIG. 3 is an example user interface;

FIG. 4 is another example user interface;

FIG. 5 shows, in flowchart form, an example method for linking a data record maintained by a third party server;

FIG. 6 is another example user interface;

FIG. 7 is another example user interface;

FIG. 8 is another example user interface;

FIG. 9 shows, in flowchart form, an example method for modifying a data record maintained by a third party server;

FIG. 10 is another example user interface;

FIG. 11 is an example web page for modifying a virtual processor;

FIG. 12 shows, in flowchart form, an example method for performing at least one alternative modification;

FIG. 13 shows, in flowchart form, an example method for updating a data record management interface;

FIG. 14 is another example user interface;

FIG. 15 is yet another example user interface;

FIG. 16 is still yet another example user interface; and

FIG. 17 is yet another example user interface.

Like reference numerals are used in the drawings to denote like elements and features.

### DETAILED DESCRIPTION OF VARIOUS EMBODIMENTS

Accordingly, in one aspect there is provided a server computer system comprising at least one processor; a communications module coupled to the at least one processor; and a memory coupled to the at least one processor, the memory storing instructions that, when executed, configure the at least one processor to send, via the communications module to a computing device, a signal that causes the computing device to display a selectable interface element for requesting modification to a data record maintained by a third party server; receive, via the communications module from the computing device, a signal indicating selection of the selectable interface element; identify at least one alternative modification based at least on the requested modification; and send, via the communications module to the computing device, a signal causing the computing device to display a recommendation for the at least one alternative modification.

In one or more embodiments, the selectable interface element includes a deep link embedded therein that causes the computing device to navigate to a web page for requesting the modification to the data record maintained by the third party server in response to selection thereof.

In one or more embodiments, the signal causing the computing device to display the recommendation interrupts navigation to the web page.

In one or more embodiments, the recommendation includes a selectable interface element for rejecting the recommendation and resuming navigation to the web page for requesting the modification to the data record maintained by the third party server.

In one or more embodiments, the recommendation includes at least one selectable interface element for accepting the recommendation for the at least one alternative modification.

In one or more embodiments, the instructions, when executed, configure the at least one processor to receive, via the communications module from the computing device, a signal indicating selection of the at least one selectable interface element for accepting the at least one alternative modification; and perform one or more operations to complete the accepted the at least one alternative modification.

In one or more embodiments, the at least one alternative modification includes modification to at least one of the data records maintained by the third party server, at least one other data record, or creating at least one other data record.

In one or more embodiments, the at least one alternative modification includes at least one alternative modification that requires less resources than the modification to the data record maintained by the third party server.

In one or more embodiments, when identifying the at least one alternative modification, the instructions, when executed, configure the at least one processor to engage a machine learning module trained to identify the at least one alternative modification.

In one or more embodiments, the instructions, when executed, configure the at least one processor to receive, via the communications module from the computing device, a signal indicating selection of a selectable interface element for accepting the at least one alternative modification; and re-train the machine learning module at least based on the accepted at least one alternative modification.

According to another aspect there is provided a computer-implemented method comprising sending, via a communications module to a computing device, a signal that causes the computing device to display a selectable interface element for requesting modification to a data record maintained by a third party server; receiving, via the communications module from the computing device, a signal indicating selection of the selectable interface element; identifying at least one alternative modification based at least on the requested modification; and sending, via the communications module to the computing device, a signal causing the computing device to display a recommendation for the at least one alternative modification.

In one or more embodiments, the selectable interface element includes a deep link embedded therein that causes the computing device to navigate to a web page for requesting the modification to the data record maintained by the third party server in response to selection thereof.

In one or more embodiments, the signal causing the computing device to display the recommendation interrupts navigation to the web page.

In one or more embodiments, the recommendation includes a selectable interface element for rejecting the recommendation and resuming navigation to the web page for requesting the modification to the data record maintained by the third party server.

In one or more embodiments, the recommendation includes at least one selectable interface element for accepting the recommendation for the at least one alternative modification.

In one or more embodiments, the method further comprises receiving, via the communications module from the computing device, a signal indicating selection of the at least one selectable interface element for accepting the at least one alternative modification; and performing one or more operations to complete the accepted the at least one alternative modification.

In one or more embodiments, the at least one alternative modification includes modification to at least one of the data records maintained by the third party server, at least one other data record, or creating at least one other data record.

In one or more embodiments, the at least one alternative modification includes at least one alternative modification that requires less resources than the modification to the data record maintained by the third party server.

In one or more embodiments, when identifying the at least one alternative modification, the method further comprises engaging a machine learning module trained to identify the at least one alternative modification; receiving, via the communications module from the computing device, a signal indicating selection of at least one selectable interface element for accepting the at least one alternative modification; and re-training the machine learning module at least based on the accepted at least one alternative modification.

According to another aspect there is provided a non-transitory computer readable storage medium comprising processor-executable instructions which, when executed, configure at least one processor to send, via a communications module to a computing device, a signal that causes the computing device to display a selectable interface element for requesting modification to a data record maintained by a third party server; receive, via the communications module from the computing device, a signal indicating selection of the selectable interface element; identify at least one alternative modification based at least on the requested modification; and send, via the communications module to the computing device, a signal causing the computing device to display a recommendation for the at least one alternative modification.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

In the present application, examples involving a general-purpose computer, aspects of the disclosure transform the general-purpose computer into a special-purpose computing device when configured to execute the instructions described herein.

In the present application, various functionalities discussed herein may be performed by a single processor or by any one of one or more processors, either alone or in combination.

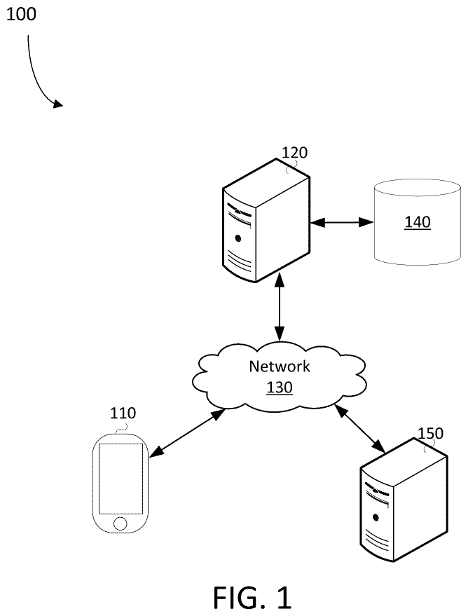

FIG. 1 is a schematic operation diagram illustrating an operating environment of an example embodiment. As shown, the system 100 includes a computing device 110 and a server computer system 120 coupled to one another through a network 130, which may include a public network such as the Internet and/or a private network. The computing device 110 and the server computer system 120 may be in geographically disparate locations. Put differently, the computing device 110 and the server computer system 120 may be located remote from one another.

The computing device 110 may take a variety of forms including, for example, a mobile communication device such as a smartphone, a tablet computer, a wearable computer (such as a head-mounted display or smartwatch), a laptop or desktop computer, or a computing device of another type. The computing device 110 may be associated with a user or customer having resources that are managed by or via the server computer system 120. For example, the server computer system 120 may be a financial institution server and the user may be a customer of a financial institution operating the financial institution server. The computing device 110 may store software instructions that cause the computing device 110 to establish communications with the server computer system 120.

The server computer system 120 may maintain a database 140 that includes various data records. For example, the server computer system 120 may be a financial institution server which may maintain customer bank accounts. In this example, a data record may, for example, reflect an amount of value stored in a particular account associated with a user. The amount of value may include a quantity of currency The database 140 may include data records for a plurality of resource accounts and at least some of the data records may define a quantity of resources associated with a user or customer. For example, the user that is associated with the computing device 110 may be associated with one or more resource accounts having one or more data records in the database 140. The data records may reflect a quantity of resources that are available to the user. Such resources may include owned resources and, in at least some embodiments, borrowed resources (e.g., resources available on credit). The quantity of resources that are available to or associated with a user may be reflected by a balance defined in an associated data record such as, for example, a bank balance. The resource accounts may include, for example, a chequing account, a savings account, a borrowing account such as for example a line of credit account, a credit card account, a loyalty point account, etc. As such, at least some of the data records may define a chequing account balance, a savings account balance, a line of credit account balance, a credit card account balance, a loyalty point account balance, etc.

The database 140 may additionally include data records for storing identity data of users or customers. The identity data may include, for example, a name, an email address, a social security number, an address, a phone number, etc. of the user. The identity data may include identity data previously-obtained to fulfill know-your-customer (KYC) requirements.

The network 130 is a computer network. In some embodiments, the network 130 may be an internetwork such as may be formed of one or more interconnected computer networks. For example, the network 130 may be or may include an Ethernet network, an asynchronous transfer mode (ATM) network, a wireless network, a telecommunications network, or the like.

The computing device 110 is adapted to present a graphical user interface that allows for communication with the server computer system 120. For example, the computing device 110 may be adapted to receive, from the server computer system 120, a signal that causes the computing device 110 to display a graphical user interface associated with a software or mobile application.

The system 100 may include a third party server 150 that maintains data records. The data records may be associated with one or more users. The third party server 150 may be associated with a third party that provides a particular service. For example, the third party server 150 may be associated with a streaming service provider, a utility service provider, an internet provider, a cable provider, a third party financial institution, a credit card provider, etc.

The data records maintained by the third party server 150 may represent accounts held by users or customers of the particular service. For example, the third party server 150 may be associated with a particular streaming service provider and as such a data record may represent an account held by a user for the particular streaming service. The data records may store account data which may include billing data representing a bill or cost for using the particular streaming service. The account data may additionally or alternatively include identity data of the user associated with the account such as for example a name, email address, address, phone number, etc. of the user. The data records may include user information records, billing and payment records, viewing and activity records, device and location data, content and media records, etc.

In one or more embodiments the data records maintained by the third party server 150 may store the data records using structured data. For example, the data records may be organized using relational databases and/or using document-based formats such as for example NoSQL databases.

In one or more embodiments, the third party server 150 may require authentication information to access the data records and the authentication information may be provided, for example, in the form of a username/password or in the form of an access token.

The third party server 150 may be configured to communicate with the server computer system 120 via the network 130. The third party server 150 may provide the server computer system 120 access to at least some data from the data records maintained thereby. The third party server 150 may communicate with the server computer system 120 to handle or otherwise handle requests for modifying one or more data records maintained thereby.

It will be appreciated that the system 100 may include additional third party servers and each third party server may be associated with a third party that provides a particular service and may maintain one or more data records.

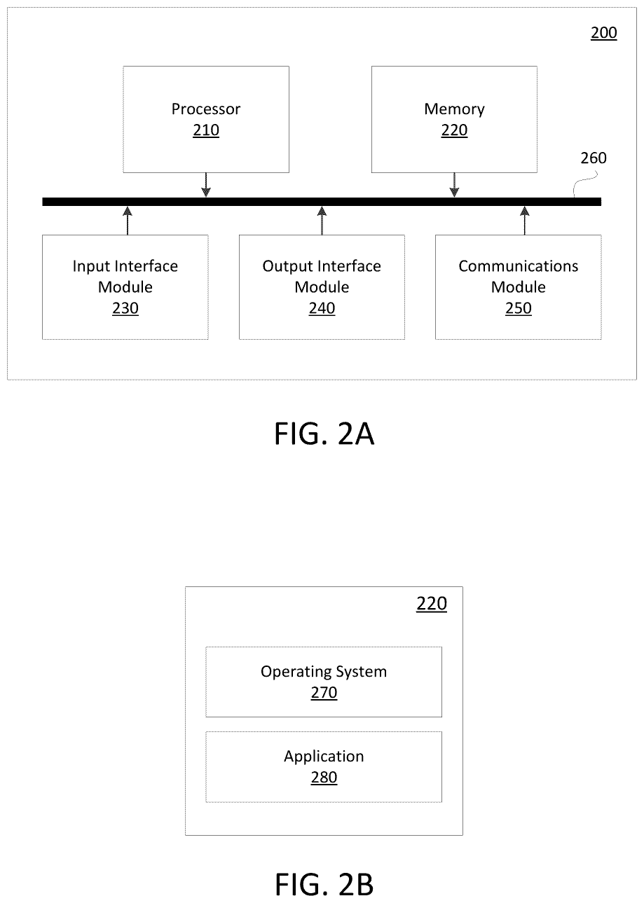

FIG. 2A is a high-level operation diagram of an example computer device 200. In some embodiments, the example computer device 200 may be exemplary of one or more of the computing device 110, the server computer system 120 and/or the third party server 150. The example computer device 200 includes a variety of modules. For example, as illustrated, the example computer device 200, may include a processor 210, a memory 220, an input interface module 230, an output interface module 240, and a communications module 250. As illustrated, the foregoing example modules of the example computer device 200 are in communication over a bus 260.

The processor 210 is a hardware processor. Processor 210 may, for example, be one or more ARM, Intel x86, PowerPC processors, or the like.

The memory 220 allows data to be stored and retrieved. The memory 220 may include, for example, random access memory, read-only memory, and persistent storage. Persistent storage may be, for example, flash memory, a solid-state drive, or the like. Read-only memory and persistent storage are a computer-readable medium. A computer-readable medium may be organized using a file system such as may be administered by an operating system governing overall operation of the example computer device 200.

The input interface module 230 allows the example computer device 200 to receive input signals. Input signals may, for example, correspond to input received from a user. The input interface module 230 may serve to interconnect the example computer device 200 with one or more input devices. Input signals may be received from input devices by the input interface module 230. Input devices may, for example, include a touchscreen input, keyboard, trackball, or the like. In some embodiments, all or a portion of the input interface module 230 may be integrated with an input device. For example, the input interface module 230 may be integrated with one of the aforementioned example input devices.

The output interface module 240 allows the example computer device 200 to provide output signals. Some output signals may, for example, allow provision of output to a user. The output interface module 240 may serve to interconnect the example computer device 200 with one or more output devices. Output signals may be sent to output devices by output interface module 240. Output devices may include, for example, a display screen such as, for example, a liquid crystal display (LCD), a touchscreen display. Additionally, or alternatively, output devices may include devices other than screens such as for example a speaker, indicator lamps (such as for example light-emitting diodes (LEDs)), and printers. In some embodiments, all or a portion of the output interface module 240 may be integrated with an output device. For example, the output interface module 240 may be integrated with one of the aforementioned example output devices.

The communications module 250 allows the example computer device 200 to communicate with other electronic devices and/or various communications networks. For example, the communications module 250 may allow the example computer device 200 to send or receive communications signals. Communications signals may be sent or received according to one or more protocols or according to one or more standards. For example, the communications module 250 may allow the example computer device 200 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally, or alternatively, the communications module 250 may allow the example computer device 200 to communicate using near-field communication (NFC), via Wi-Fi (TM), using Bluetooth (TM) or via some combination of one or more networks or protocols. Contactless payments may be made using NFC. In some embodiments, all or a portion of the communications module 250 may be integrated into a component of the example computer device 200. For example, the communications module may be integrated into a communications chipset.

Software comprising instructions is executed by the processor 210 from a computer-readable medium. For example, software may be loaded into random-access memory from persistent storage of memory 220. Additionally, or alternatively, instructions may be executed by the processor 210 directly from read-only memory of memory 220.

FIG. 2B depicts a simplified organization of software components stored in memory 220 of the example computer device 200. As illustrated these software components include an operating system 270 and an application 280.

The operating system 270 is software. The operating system 270 allows the application 280 to access the processor 210, the memory 220, the input interface module 230, the output interface module 240 and the communications module 250. The operating system 270 may be, for example, Apple iOS™, Google Android™, Linux™, Microsoft Windows™, or the like.

The application 280 adapts the example computer device 200, in combination with the operating system 270, to operate as a device performing specific functions. It will be appreciated that although a single application 280 is shown, in operation the memory 220 may include more than one application 280 and different applications 280 may perform different operations. For example, in at least some embodiments in which the computer device 200 is functioning as the computing device 110, the applications 280 may include a banking application. The banking application may be configured for secure communications with the server computer system 120 and may provide various banking functions such as, for example, the ability to display a quantum of value in one or more data records (e.g. display balances), configure or request that operations such as transfers of value (e.g. bill payments, email money transfers and other transfers) be performed, and other account management functions.

By way of further example, in at least some embodiments in which the computer device 200 functions as the computing device 110, the applications 280 may include a web browser, which may also be referred to as an Internet browser. In at least some such embodiments, the server computer system 120 may be a web server. The web server may cooperate with the web browser and may serve as an interface when the interface is requested through the web browser. For example, the web browser may serve as a mobile banking interface. The mobile banking interface may provide various banking functions such as, for example, the ability to display a quantum of value in one or more data records (e.g. display balances), configure or request that operations such as transfers of value (e.g. bill payments and other transfers) be performed, and other account management functions.

By way of further example, in at least some embodiments in which the computer device 200 functions as the computing device 110, the applications 280 may include a data record management application. The data record management application may be configured for secure communications with the server computer system 120 and may provide various data record management functions such as for example the ability to link one or more data records maintained by one or more third party servers, the ability to display data retrieved from one or more data records maintained by one or more third party servers, request modification to one or more data records maintained by one or more third party servers, and other data record functions. It will be appreciated that the data record management application may be provided as a separate application and/or may be associated with or available within another application.

The user may access the data record management application on the computing device 110. For example, the user may select a selectable interface element within a mobile application that, when selected, directs the computing device 110 to the data record management application. As another example, the data record management application may be downloaded onto the computing device 110. As another example, the computing device 110 may access the data record management application using an internet browser resident on the computing device 110.

The user may be required to provide authentication information to access the data record management application. For example, using the computing device 110, the user may enter a username and password associated with their account and the computing device 110 may send a signal that includes the username and password to the server computer system 120. The server computer system 120 may verify the authentication information and may identify the account of the user.

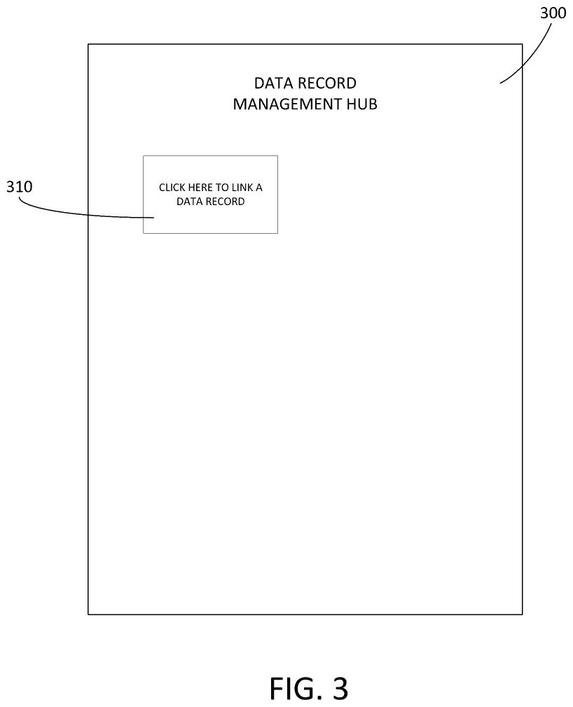

Within the data record management application, the computing device 110 may display a data record management interface. An example data record management interface 300 is shown in FIG. 3. As can be seen, the data record management interface 300 includes a selectable interface element 310 that, when selected, sends a signal to the server computer system 120 indicating that the user would like to link one or more data records maintained by one or more third party servers. The selectable interface element 310 may be selected by the user performing, for example, a tap gesture on a display screen of the computing device 110 at a location corresponding to the selectable interface element 310.

Responsive to the user selecting the selectable interface element 310, the computing device 110 displays a list. The list may be a predefined or predetermined list generated by the server computer system 120. The list may include a number of data record managers such as for example one or more third party servers that maintain data records, database management services, cloud-based data managers, etc. In one or more embodiments, the one or more third party servers that maintain data records may be associated with subscription-based services such as for example streaming services. The list may be a list of data record managers that the server computer system 120 is able to access data records therefrom. For example, the list may only include data record managers that are associated with third party servers that the server computer system 120 is able to communicate with or has previously communicated with. The list may additionally or alternatively include providers that provide an application programming interface (API) that may be engaged by the server computer system 120 to handle API requests.

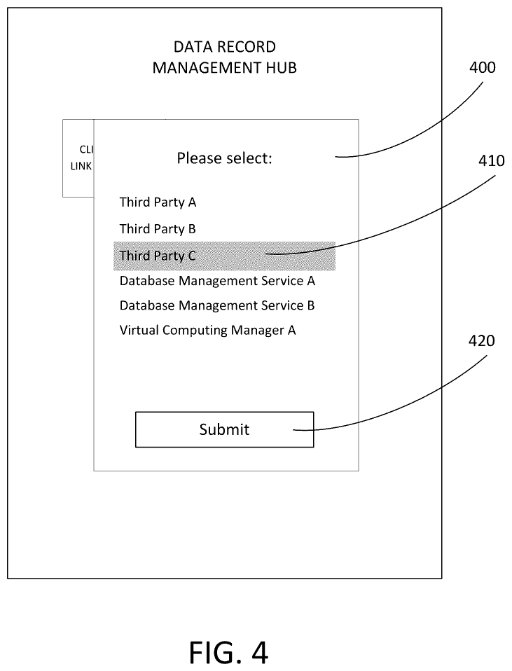

An example interface 400 that includes a list 410 is shown in FIG. 4. In this example, the interface 400 is displayed such that it overlaps the data record management interface 300 shown in FIG. 3. The list 410 includes data record managers known to the server computer system 120. A data record manager may be selected by the user performing, for example, a tap gesture on a display screen of the computing device 110 at a location corresponding to one of the providers. The interface 400 includes a selectable interface element 420 that, when selected, causes the computing device 110 to send a signal to the server computer system 120 that includes information identifying the selected data record manager.

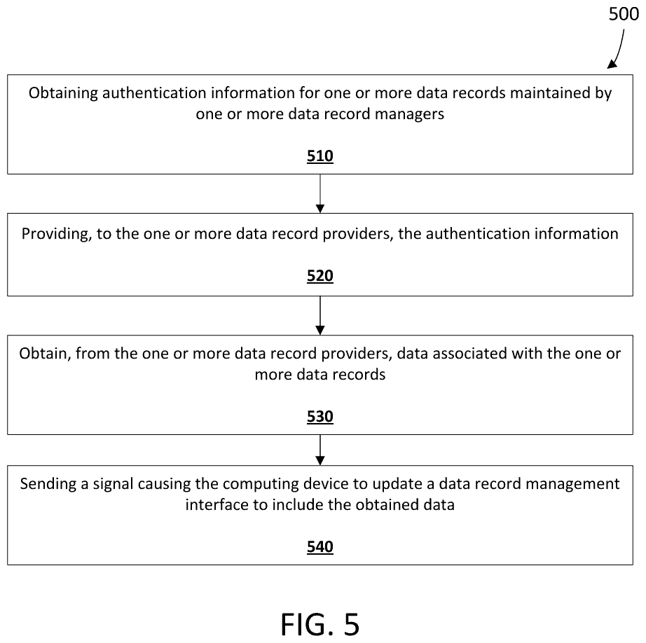

Once a provider has been selected, a method for linking a data record maintained by a third party server is performed. Reference is made to FIG. 5, which illustrates, in flowchart form, a method 500 for linking a data record maintained by a third party server. The method 500 may be implemented by a computing device having suitable processor-executable instructions for causing the computing device to carry out the described operations. The method 500 may be implemented, in whole or in part, by the server computer system 120. The server computer system 120 may off-load some operations of the method 500 to the computing device 110 (FIG. 1).

The method 500 includes obtaining authentication information for one or more data records maintained by one or more data record managers (step 510).

The one or more data records maintained by the one or more additional third party servers may be associated with a user or an account of the user.

In this embodiment, responsive to receiving the signal that includes information identifying the selected data record manager, the server computer system 120 sends a signal causing the computing device 110 to display an interface requesting authentication information that may be used to access the data record maintained by the selected data record manager. It will be appreciated that different data record managers may require different types of authentication information and as such the interface may be dependent on the selected data record manager. For example, a first data record manager may require a username and a password to access a data record maintained thereby. As another example, a second data record manager may require a data record number and a password to access the data record. The server computer system 120 may store information identifying what type of authentication information is required for each data record manager in the database 140. For example, the server computer system 120 and/or the database 140 may maintain a lookup table that includes a list of the data record managers and the type of authentication information required to access a data record maintained thereby. In this manner, the server computer system 120 may update, adjust or modify the interface prior to it being displayed on the computing device 110 to ensure that the requested authentication information is accurate for the selected data record manager.

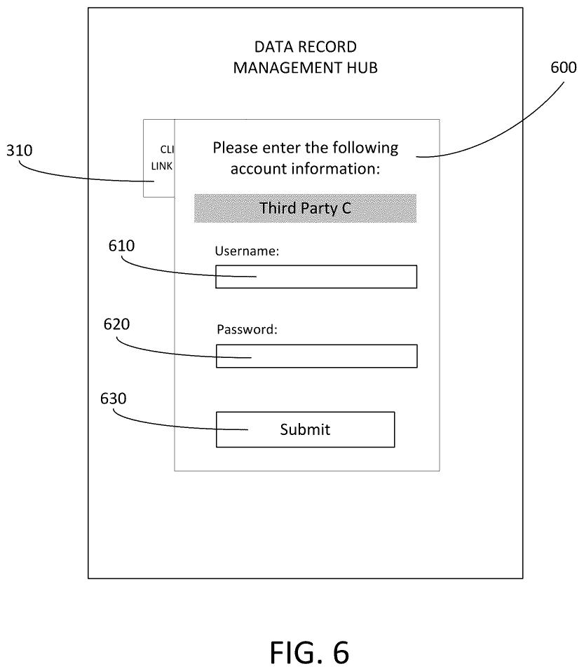

An example interface 600 requesting that the user provide authentication information is shown in FIG. 6. As can be seen, the interface 600 includes a first input field 610 to enter a username associated with a data record and a second input field 620 to enter a password associated with the data record. The interface 600 includes a selectable interface element 630 that, when selected, sends a signal that includes the authentication information to the server computer system 120. Once received, the server computer system 120 may store the authentication information in memory. The user may complete the first input field 610 and the second input field 620 using, for example, a keyboard displayed on a display screen of the computing device 110.

The method 500 includes providing, to the one or more data record managers, the authentication information (step 520).

Once the authentication information has been received, the server computer system 120 uses the authentication information to access the data record. For example, the server computer system 120 may send a signal to a third party server associated with a data record manager that includes the authentication information and requests data therefrom. In response, the third party server may analyze the authentication information to authenticate the server computer system 120 and identify the data record. Once authenticated, the third party server may retrieve data from the data record and may send the data to the server computer system 120.

In one or more embodiments, the server computer system 120 may engage an application programming interface (API) associated with the third party server and may send, for example, an API request that includes the authentication information and requests data from the third party server.

The requested data may include data retrieved directly from the data record. For example, the requested data may include account data such as for example a balance owing, usage data such as for example internet usage, etc.

The method 500 includes obtaining, from the one or more additional third party servers, data associated with the one or more data records (step 530).

In this embodiment, the third party server may obtain the data associated with the one or more data records. For example, the server computer system 120 may request data from the data record that includes the balance of the account and a due date for when the balance is to be paid. As such, the third party server may obtain the balance of the account and the due date for when the balance is to be paid and may send the obtained data to the server computer system 120. In this manner, the server computer system 120 obtains the data associated with the one or more data records.

The method 500 includes sending a signal causing the computing device to update the data record management interface to include the obtained data (step 540).

The server computer system 120 sends a signal that causes the computing device 110 to update the data record management interface to include the obtained data.

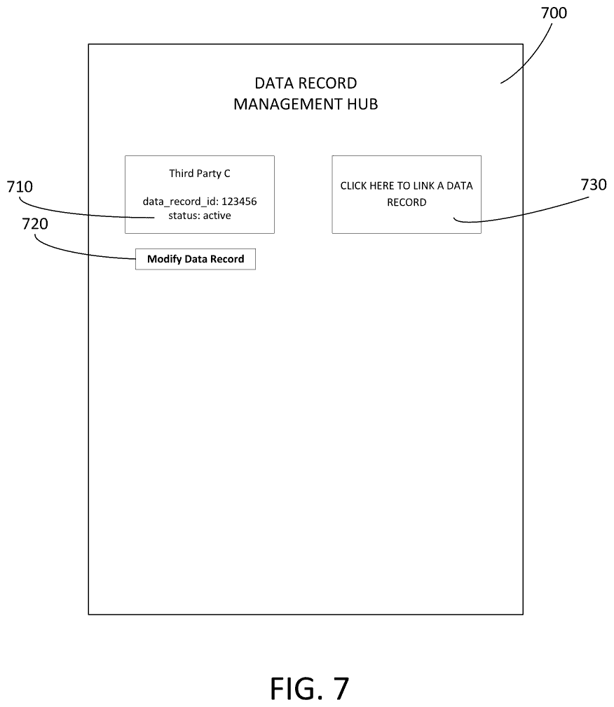

An example interface 700 is shown in FIG. 7. As can be seen, the interface 700 includes a graphic element 710 that includes the data associated with the one or more data records obtained from the third party server. Specifically, the graphic element 710 includes identifying information of the data record manager (“Third Party C”) and the data associated with the one or more data records obtained from the third party server which in this example includes a data record ID (“data_record_id: 123456”) and data record status (“status:active”). The interface 700 includes a selectable interface element 720 for requesting modification to the data record maintained by the third party server. Once the user has selected the selectable interface element 720, the server computer system 120 may perform operations to modify the data record, as will be described in more detail below.

The graphic element 710 may itself be selectable by the user. For example, the user may perform a tap gesture on a display screen of the computing device 110 at a location corresponding to the graphic element 710. In one example, responsive to the user selecting the graphic element 710, the server computer system 120 may send additional data for display on the computing device 110. For example, the server computer system 120 may send usage data obtained from the third party server and this may be displayed on the computing device 110. In another example, responsive to the user selecting the graphic element 710, the computing device 110 may be directed to a mobile application or website hosted by the third party server. In another example, responsive to the user selecting the graphic element 710, the computing device 110 may display a settings or configuration page that may be used by the user to update or change one or more settings.

The interface 700 may additionally include a selectable interface element 730 that may be selected by the user to link one or more additional data records and this may be completed in manners similar to that described herein. Once completed, data for all linked data records may be displayed.

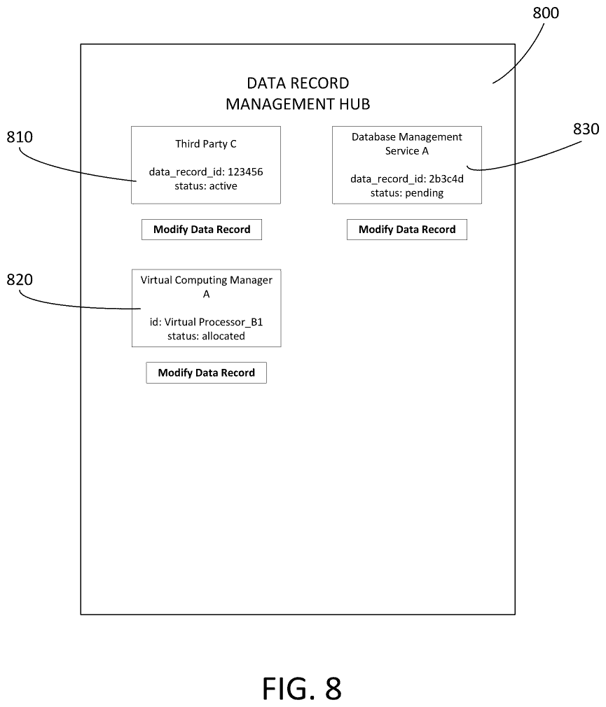

An example interface 800 is shown in FIG. 8. As can be seen, the interface 800 includes graphic elements 810, 820, 830 each of which are associated with a particular data record that has been linked to the data record management hub. In this manner, each time the user accesses the data record management hub, the server computer system 120 may perform steps to obtain up-to-date data and display the up-to-date data within the graphic elements 810, 820, 830.

As mentioned, responsive to selection of a selectable interface element, the server computer system 120 may perform operations to modify a data record.

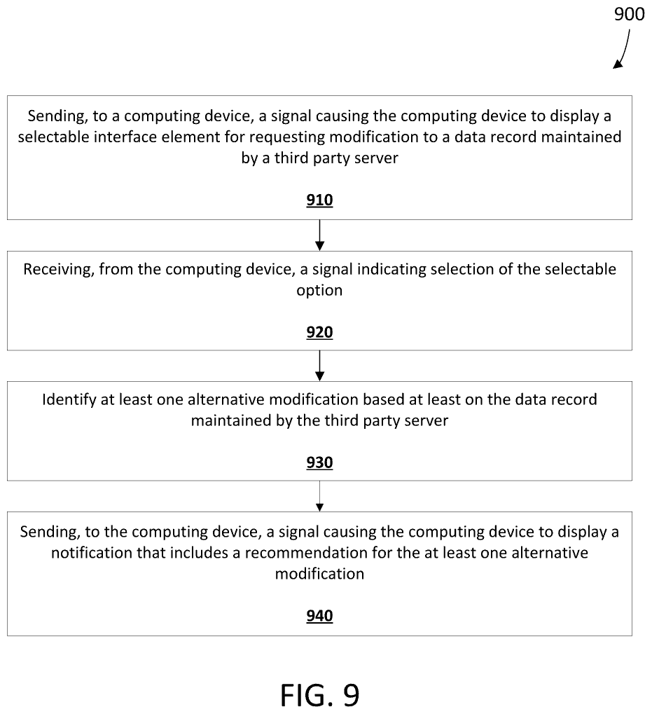

Reference is made to FIG. 9, which illustrates, in flowchart form, a method 900 for modifying a data record maintained by a third party server. The method 900 may be implemented by a computing device having suitable processor-executable instructions for causing the computing device to carry out the described operations. The method 900 may be implemented, in whole or in part, by the server computer system 120. The server computer system 120 may off-load some operations of the method 900 to the computing device 110 (FIG. 1).

The method 900 includes sending, to a computing device, a signal that causes the computing device to display a selectable interface element for requesting modification to a data record maintained by a third party server (step 910).

The selectable interface element may be displayed within the data record management application. For example, as described herein with reference to FIG. 7, the interface 700 includes a selectable interface element 720 for requesting modification to the data record maintained by the third party server. It will be appreciated that a selectable interface element may be displayed adjacent to each linked data record within the data record management application, such as shown in FIG. 8.

In one or more embodiments, the selectable interface element may include a deep link embedded therein that causes the computing device to navigate to a web page for requesting the modification to the data record maintained by the third party server in response to selection thereof. For example, the deep link may include a Uniform Resource Locator (URL) that hyperlinks to a specific page or piece of a web site or mobile application. The URL may include all information needed to point to a particular item.

In one or more embodiments, the deep link may link to a particular web page for modifying the data record. For example, the third party server may be associated with a virtual computing manager that manages virtual machines. The deep link may link to a specific page of a website or mobile application associated with the third party server. The specific page may include a page for modifying network configuration data records of the virtual machines such as for example modifying an IP address assigned to one or more virtual machines.

As another example, the third party server may be associated with a streaming service and may manage data records associated with user accounts. The deep link may link to a specific page of a website or mobile application associated with the third party server. The specific page may include a page for modifying or adjusting the subscription and/or for cancelling the subscription.

The deep links assigned to the selectable interface elements may be maintained by the server computer system 120. For example, the database 140 may maintain a lookup table that associates one or more deep links to a data record manager and as such each time a data record manager is added to the data record management application by a user, the server computer system 120 may perform operations to retrieve the deep link and assign it to the selectable interface element for that data record manager.

The method 900 includes receiving, from the computing device, a signal indicating selection of the selectable interface element (step 920).

The user may select the selectable interface element by performing, for example, a tap gesture or a mouse click at a location of a display screen of the computing device 110 corresponding to the selectable interface element. In response, the computing device 110 may send a signal indication selection of the selectable interface element. In this manner, the server computer system 120 receives the signal indicating selection of the selectable interface element.

The method 900 includes identifying at least one alternative modification based at least on the requested modification (step 930).

The at least one alternative modification may include a modification that is to be made in place of the requested modification or in addition to the requested modification. The at least one alternative modification may include at least one of at least one alternative modification to the data record maintained by the third party server, at least one alternative modification to another data record maintained by the third party server, at least one alternative modification to a data record maintained by another third party server, at least one alternative modification to a data record maintained by the server computer system 120 and/or the database 140, or creating another data record at the third party server, at another third party server, or at the database 140.

In one or more embodiments, the server computer system 120 may identify the requested modification. For example, the selectable interface element may be associated with a particular modification. For example, the selectable interface element may be associated with modifying or changing a status of the data record. In this example, rather than displaying text “Modify Data Record” on the selectable interface element (as shown in FIG. 7 and FIG. 8), text such as “Update Status” or “Cancel” may be displayed. As such, selection of the selectable interface element may identify the requested modification.

In one or more embodiments, more than one selectable interface element may be displayed for a data record manager. For example, a first selectable interface element may be associated with a first modification to be made and a second selectable interface element may be associated with a second modification to be made. The server computer system 120 may identify the requested modification based on which selectable interface element is selected by the user.

As another example, to identify the requested modification, responsive to selection of the selectable interface element, the server computer system 120 may send a signal causing the computing device 110 to display a notification that includes a list of modifications that may be made to the data record. The user may select one or more of the modifications and in response the selected modifications may be sent to the server computer system 120. For example, the user may wish to modify network configuration data records of the virtual machines and as such may select this modification from the list. In this manner, the requested modification may be identified based on user selection.

In one or more embodiments, the list of modifications may be generated based on the data record manager. For example, the database 140 may maintain a list of all data record modifications that may be available for the data record manager and may present the list in response to selection of the selectable interface element.

It will be appreciated that in one or more embodiments, within the data record management application, the user may configure or otherwise define the modification to be made for each data manager linked therein. For example, when linking a data manager, the user may be presented with one or more selectable options to define a modification that is to be associated with the selectable interface element. In this manner, the data record management application may be customized by the user to ensure that preferred or frequent data record modifications may be easily requested by the user.

In one or more embodiments, prior to identifying the at least one alternative modification, the server computer system 120 may determine whether or not the at least one alternative modification is required. For example, the server computer system 120 may communicate with the third party server to determine whether or not the requested modification is able to be made. The server computer system 120 may receive, from the third party server, an indication that the requested modification is available and as such the server computer system 120 may perform operations to complete the requested modification.

As one example, the requested modification may include modifying an IP address of a virtual machine. The server computer system 120 may communicate with a third party server associated with managing the virtual machine to determine whether or not the virtual machine is currently being accessed. If the virtual machine is not currently being accessed, the third party server may send a signal to the server computer system 120 indicating that the virtual machine is not currently being accessed and as such the requested modification is available to be made. If, however, the virtual machine is currently being accessed, the third party server may send a signal to the server computer system 120 indicating that the virtual machine is being accessed and as such the requested modification cannot be made at this time. As such, the server computer system 120 may perform operations to identify at least one alternative modification.

As another example, the server computer system 120 may send a signal to the third party server indicating the requested modification to the data record. The third party server may determine, based on the data record and/or the requested modification, whether or not an alternative modification is to be presented. The third party server may communicate an indication to the server computer system 120 that an alternative modification is to be presented and in response the server computer system 120 may perform operations to identify at least one alternative modification. Of course, the third party server itself may identify the at least one alternative modification and may send the at least one alternative modification to the server computer system 120.

The server computer system 120 identifies at least one alternative modification based at least on the requested modification.

In one or more embodiments, the database 140 may maintain a list of one or more alternative modifications that may be made in place of or in addition the requested modification. As such, in response to identifying the requested modification, the server computer system 120 may consult the database 140 to identify the one or more alternative modifications.

As mentioned, in one or more embodiments, the third party server may send the server computer system 120 the at least one alternative modification. As such, the server computer system 120 may identify the at least one alternative modification based on the response from the third party server.

In one or more embodiments, the server computer system 120 may utilize or engage a machine learning module that is trained to identify the at least one alternative modification. For example, the server computer system 120 may generate one or more sets of training data that includes requested modifications and accepted alternative modifications. The machine learning module may utilize machine learning techniques to identify the at least one alternative modification. The machine learning module may generate the recommendations in real-time or near-real-time at request of the server computer system 120.

The at least one alternative modification may include at least one alternative modification to the data record maintained by the third party server. For example, the requested modification may include a request to modify an IP address of a virtual machine and the at least one alternative modification may include assigning a domain name system to the data record. In this example, rather than modifying the IP address, a domain name may be assigned and used and as such, even if the underlying IP address of the virtual machine changes, clients can still connect to the virtual machine using the domain name. In this example, the at least one alternative modification may include a modification that is to be made in place of the requested modification. Specifically, rather than changing the IP address of a virtual machine that is currently being used, a domain name system may be assigned.

As another example, the requested modification may include a request to change a status of the data record maintained by the third party server. The change of status may include a change in subscription status from “active” to “cancelled” or “pending cancellation.” The at least one alternative modification may include modifying the data record maintained by the third party server to reduce a cost of the service offered by the third party server. In this example, the at least one alternative modification may include a modification that is to be made in place of the requested modification. Specifically, rather than cancelling a subscription status of a service offered by the third party server, the cost of the subscription service may be reduced. In this manner, the at least one alternative modification may serve as an incentive to prevent cancelling the service offered by the third party server.

The at least one alternative modification may include at least one alternative modification to another data record maintained by the third party server. For example, the requested modification may include a request to modify an IP address of a virtual machine. It may be determined that the virtual machine is currently being used or accessed and as such the at least one alternative modification may include modifying a data record of another virtual machine that is not currently being used. In this example, the at least one alternative modification may include a modification that is to be made in place of the requested modification. Specifically, rather than modifying the IP address of the virtual machine as it is currently being used or accessed, the IP address of an available virtual machine may be modified.

The at least one alternative modification may include at least one alternative modification to another data record maintained by another third party server. For example, the requested modification may include a request to modify an IP address of a virtual machine. It may be determined that all virtual machines are currently being used or accessed and as such the at least one alternative modification may include modifying a data record of another virtual machine that is maintained by another third party system. In this example, the at least one alternative modification may include a modification that is to be made in place of the requested modification. Specifically, rather than modifying the IP address of the virtual machine as it is currently being used or accessed, the IP address of a virtual machine maintained by another third party server may be modified.

The at least one alternative modification may include at least one alternative modification to a data record maintained by the server computer system 120 which may include a data record stored in the database 140. For example, the requested modification may include a request to change a status of the data record maintained by the third party server. The change of status may include a change in subscription status from “active” to “cancelled” or “pending cancellation.” The at least one alternative modification may include modifying a data record maintained by the server computer system 120. For example, the database 140 may include data records for a plurality of resource accounts which may include a loyalty points account. As such, the at least one alternative modification may include crediting the loyalty points account with a particular amount of loyalty points. In this example, the at least one alternative modification may include a modification that is to be made in place of the requested modification. Specifically, loyalty points may be credited in the loyalty points account rather than cancelling a subscription status of a service offered by the third party server. In this manner, the at least one alternative modification may serve as an incentive to prevent cancelling the service offered by the third party server.

The at least one alternative modification may include creating a data record at another third party server. For example, the requested modification may include a request to change a status of the data record maintained by the third party server. The change of status may include a change in subscription status from “active” to “cancelled” or “pending cancellation.” The at least one alternative modification may include creating a data record at another third party server. For example, the another third party server may offer a similar subscription as the third party server and as such the at least one alternative modification may include creating a data record and thus an account at the another third party server. The similar subscription may include a subscription that has a lower cost or price than the subscription offered by the third party server or may include a trial subscription that has no cost. In this example, the at least one alternative modification may include a modification that is to be made in addition to the requested modification. Specifically, a new data record is to be created at another third party server while the subscription status of the data record maintained by the third party server is to be changed from “active” to “cancelled”. In this manner, the at least one alternative modification may serve as an incentive to sign up for a service offered by the another third party server while at the same time cancelling the service offered by the third party server.

In one or more embodiments, the at least one alternative modification may include at least one modification that requires less resources than the modification to the data record maintained by the third party server. For example, the server computer system 120 may determine or identify an amount of computing resources required to perform the modification to the data record and this may be based on, for example, network traffic and historical data. The server computer system 120 may identify one or more alternative modifications and may determine or identify an amount of computing resources required to perform the alternative modification to the data record and this may be based on, for example, network traffic and historical data. The server computer system 120 may identify the at least one alternative modification based on what alternative modifications require fewer computing resources than the requested modification. In this example, the at least one alternative modification may include a modification that is to be made in place of the requested modification.

As another example, the server computer system 120 may identify at least one alternative data record that requires less resources than the data record maintained by the third party server. For example, the requested modification may include a request to change a status of the data record maintained by the third party server. The change of status may include a change in subscription status from “active” to “cancelled” or “pending cancellation.” The at least one alternative modification may include creating a data record at another third party server. For example, the another third party server may offer a similar subscription as the third party server that requires less resources or has a lower cost or price than the subscription offered by the third party server. As such the at least one alternative modification may include creating a data record and thus an account at the another third party server. In this example, the at least one alternative modification may include a modification that is to be made in addition to the requested modification. Specifically, a new data record is to be created at another third party server while the subscription status of the data record maintained by the third party server is to be changed from “active” to “cancelled”. In this manner, the at least one alternative modification may serve as an incentive to sign up for a service offered by the another third party server that has a lower cost than the service offered by the third party server while at the same time cancelling the service offered by the third party server.

The method 900 includes sending, to the computing device, a signal causing the computing device to display a recommendation for the at least one alternative modification (step 940).

Once the at least one alternative modification has been identified, the server computer system may generate a recommendation for the at least one alternative modification. Once the recommendation has been generated, the server computer system 120 may send a signal causing the computing device 110 to display the recommendation. The signal may cause the computing device 110 to update the data record management interface to include the recommendation. For example, the interface 800 shown in FIG. 8 may be updated to include the recommendation.

The signal causing the computing device to display the recommendation may interrupt navigation to a web page. For example, as mentioned, in one or more embodiments the selectable interface element for requesting modification to the data record may include a deep link embedded therein that causes the computing device to navigate to a web page for requesting the modification to the data record maintained by the third party server in response to selection thereof. For example, as described, the deep link may include a Uniform Resource Locator (URL) that hyperlinks to a specific page or piece of a web site or mobile application for modifying the data record. In these embodiments, in response to selection of the selectable interface element for requesting modification to the data record, the server computer system 120 may perform operations in real-time or near real-time to determine whether at least one alternative modification is to be presented and to identify the at least one alternative modification. The server computer system 120 may then send a signal that interrupts the navigation of the computing device 110 to the web page and causes the computing device 110 to display the recommendation.

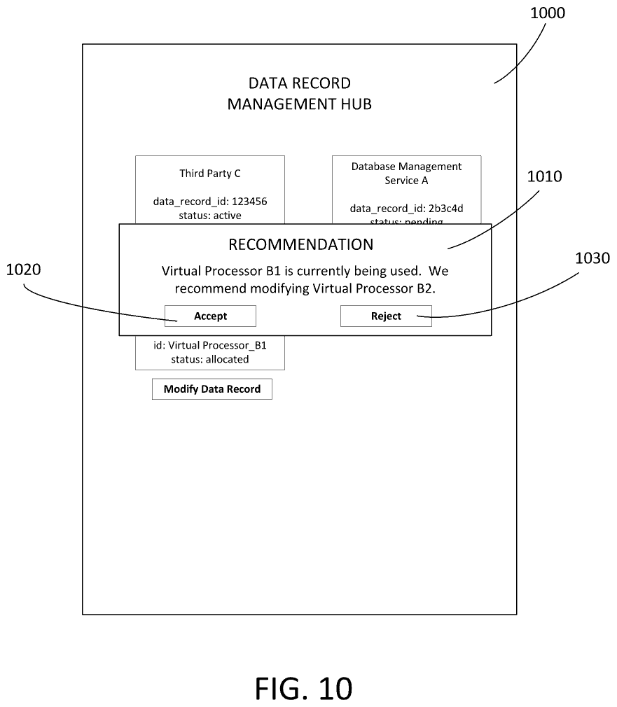

An example user interface 1000 that includes a recommendation 1010 is shown in FIG. 10. The recommendation 1010 is a recommendation for at least one alternative modification which in this example is a recommendation to modify a data record for Virtual Processor B2. The recommendation 1010 includes a selectable interface element 1020 that, when selected, indicates that the user accepts the recommendation and a selectable interface element 1030 that, when selected, indicates that the user rejects the recommendation.

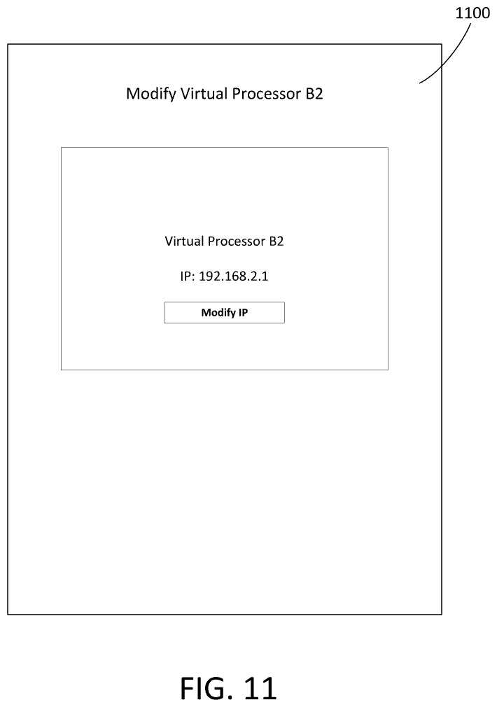

In response to the user selecting the selectable interface element 1020 indicating that the user accepts the recommendation, the server computer system 120 may send a signal to the computing device 110 to navigate to a web page for requesting or otherwise completing the at least one alternative modification which in this example is a web page for modifying the data record for Virtual Processor B2. An example web page 1100 for modifying the data record for Virtual Processor B2 is shown in FIG. 11.

In embodiments where the recommendation is displayed by interrupting the navigation of the computing device 110 to the web page for requesting the modification to the data record, selection of the selectable interface element 1030 may indicate that the user rejects the recommendation and in response the navigation of the computing device 110 to the web page for requesting the modification to the data record may be resumed. Put another way, the user may select the selectable interface element 1030 indicating rejection of the at least one recommendation. In response, the computing device 110 may receive a signal indicating selection of the selectable interface element 1030. The server computer system 120 may then send a signal to the computing device 110 to resume navigation of the computing device 110 to the web page for requesting the modification to the data record.

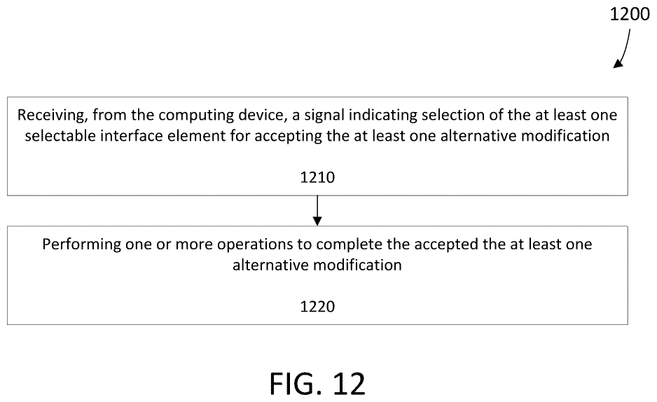

As mentioned, the recommendation includes at least one selectable interface element for accepting the recommendation for the at least one alternative modification. Reference is made to FIG. 12, which illustrates, in flowchart form, a method 1200 for performing the at least one alternative modification. The method 1200 may be implemented by a computing device having suitable processor-executable instructions for causing the computing device to carry out the described operations. The method 1200 may be implemented, in whole or in part, by the server computer system 120. The server computer system 120 may off-load some operations of the method 1200 to the computing device 110 (FIG. 1).

The method 1200 includes receiving, from the computing device, a signal indicating selection of the at least one selectable interface element for accepting the at least one alternative modification (step 1210).

Responsive to the user selecting the selectable interface element to accept the at least one alternative modification, the computing device 110 may send a signal to the server computer system 120 indicating selection of the selectable interface element.

The method 1200 includes performing one or more operations to complete the accepted the at least one alternative modification (step 1220).

Responsive to receiving the signal indicating selection of the selectable interface element to accept the at least one alternative modification, the server computer system 120 may perform one or more operations to complete the accepted the at least one alternative modification.

In one or more embodiments, the selectable interface element to accept the at least one alternative modification may include a deep link embedded therein that causes the computing device to navigate to a web page for performing the at least one alternative modification. As such, the computing device may perform operations to cause the computing device 110 to navigate to the web page for performing the at least one alternative modification.

As mentioned, the at least one alternative modification may include at least one alternative modification to the data record maintained by the third party server. For example, the requested modification may include a request to modify an IP address of a virtual machine and the at least one alternative modification may include assigning a domain name system to the data record. In this example, rather than modifying the IP address, a domain name may be assigned and used and as such, even if the underlying IP address of the virtual machine changes, clients can still connect to the virtual machine using the domain name. In this example, in response to receiving the signal indicating selection of the selectable interface element to accept the at least one alternative modification, the server computer system 120 may perform operations to cause the computing device 110 to navigate to a web page for assigning a domain name system to the data record or may communicate directly with the third party server to assign the domain name system to the data record.

As mentioned, the at least one alternative modification may include modifying the data record maintained by the third party server to reduce a cost of the service offered by the third party server. In this example, in response to receiving the signal indicating selection of the selectable interface element to accept the at least one alternative modification, the server computer system 120 may perform operations to cause the third party server to modify the data record to reduce a cost of the service offered by the third party server.

As mentioned, the at least one alternative modification may include at least one alternative modification to another data record maintained by the third party server. For example, the requested modification may include a request to modify an IP address of a virtual machine. It may be determined that the virtual machine is currently being used or accessed and as such the at least one alternative modification may include modifying a data record of another virtual machine that is not currently being used. In this example, in response to receiving the signal indicating selection of the selectable interface element to accept the at least one alternative modification, the server computer system 120 may perform operations to cause the computing device 110 to navigate to a web page to modify a data record of another virtual machine or may communicate directly with the third party server to modify the data record of the another virtual machine. Similar operations may be performed in examples where the at least one alternative modification includes at least one alternative modification to another data record maintained by another third party server.

As mentioned, the at least one alternative modification may include at least one alternative modification to a data record maintained by the server computer system 120 which may include a data record stored in the database 140. For example, the requested modification may include a request to change a status of the data record maintained by the third party server. The change of status may include a change in subscription status from “active” to “cancelled” or “pending cancellation.” The at least one alternative modification may include modifying a data record maintained by the server computer system 120. For example, the database 140 may include data records for a plurality of resource accounts which may include a loyalty points account. As such, the at least one alternative modification may include crediting the loyalty points account with a particular amount of loyalty points. In this example, in response to receiving the signal indicating selection of the selectable interface element to accept the at least one alternative modification, the server computer system 120 may perform operations to credit the loyalty points account with a particular amount of loyalty points.

As mentioned, the at least one alternative modification may include creating a data record at another third party server. For example, the requested modification may include a request to change a status of the data record maintained by the third party server. The change of status may include a change in subscription status from “active” to “cancelled” or “pending cancellation.” The at least one alternative modification may include creating a data record at another third party server. For example, the another third party server may offer a similar subscription as the third party server and as such the at least one alternative modification may include creating a data record and thus an account at the another third party server. The similar subscription may include a subscription that has a lower cost or price than the subscription offered by the third party server or may include a trial subscription that has no cost. In this example, the server computer system 120 may perform operations to change the status of the data record maintained by the third party server and to perform operations to create the data record at the another third party server.

In one or more embodiments, to create the data record at the another third party server, the server computer system 120 may engage the another third party server to initiate creation of the data record. In this example, a minimum amount of identity data may be required to initiate the creation of the data record. For example, the another third party server may require a name, an email address and a mailing address of the user prior to creating the data record. As such, the server computer system 120 may identify or determine what identity data is required to create the data record. The server computer system 120 may request this information from the another third party server, either directly or via the API, or may have previously stored this information in memory such as in the database 140. The server computer system 120 may then perform operations to obtain the identity data required and at least some of the identity data may be retrieved from the database 140, the third party server, or may be requested from the user. The identity data may be provided to the at least one another third party server and the another third party server may then create the data record.

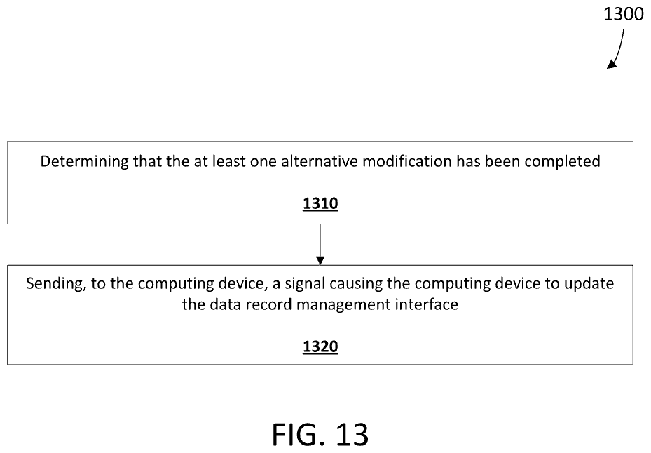

In one or more embodiments, once the at least one alternative modification has been performed, the server computer system 120 may perform operations to update the data record management interface. Reference is made to FIG. 13, which illustrates, in flowchart form, a method 1300 for updating the data record management interface. The method 1300 may be implemented by a computing device having suitable processor-executable instructions for causing the computing device to carry out the described operations. The method 1300 may be implemented, in whole or in part, by the server computer system 120. The server computer system 120 may off-load some operations of the method 1300 to the computing device 110 (FIG. 1).

The method 1300 includes determining that the at least one alternative modification has been completed (step 1310).

The server computer system 120 may determine that the at least one alternative modification has been completed based on a determination that all operations required to complete the at least one alternative modification have been completed by the server computer system 120 and/or by one or more third party services.

The method 1300 includes sending, to the computing device, a signal causing the computing device to update the data record management interface (step 1320).

The server computer system 120 sends a signal that causes the computing device 110 to update the data record management interface based on the completed alternative modification. For example, the status of one or more data records may have changed based on the completion of the at least one alternative modification and as such the data record management interface may be updated. As another example, a new data record may be created at another third party server and as such the data record management interface may be updated to include data from the new data record.

The data from the new data record may be obtained from the another third party server that created the data record. For example, the data may be obtained from the another third party server once the data record creation has completed and the data record management interface may be updated.

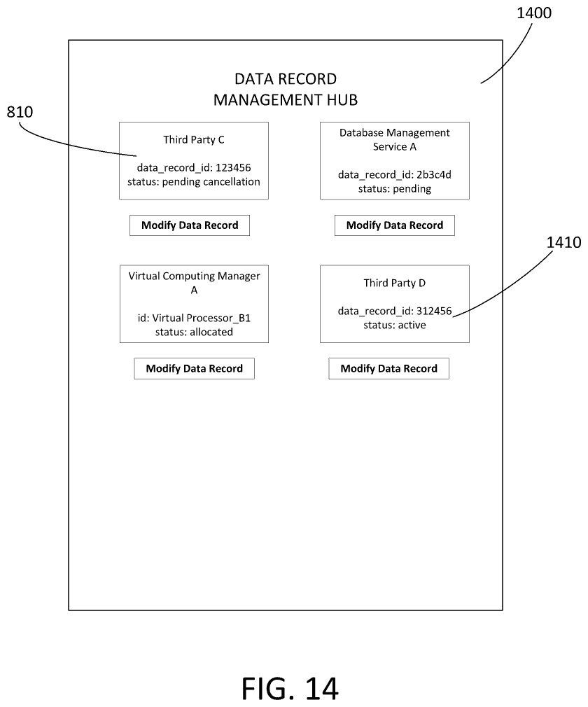

An example interface 1400 is shown in FIG. 14. The example interface 1400 is an updated version of the interface 800. As can be seen, the updated interface 1400 includes a graphic element 1410 that includes the data of a newly opened data record. Specifically, the graphic element 1410 includes identifying information of the data record manager (“Third Party D”) and data which in this example includes a data record ID and a data record status. Further, the interface 1400 includes an updated status of graphic element 810 which now indicates that the data record status is “pending cancellation”.

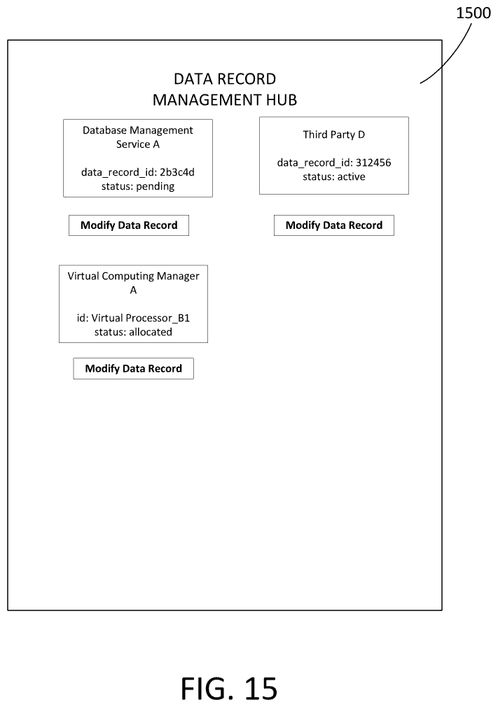

In one or more embodiments, the server computer system 120 may update the interface once the status of the data record maintained by Third Party C has changed from “pending cancellation” to “cancelled”. An example interface 1500 is shown in FIG. 15. As can be seen, the graphic element associated with the data record maintained by Third Party C has been removed since the status changed to “cancelled”. All other graphic elements have been rearranged by the server computer system 120.

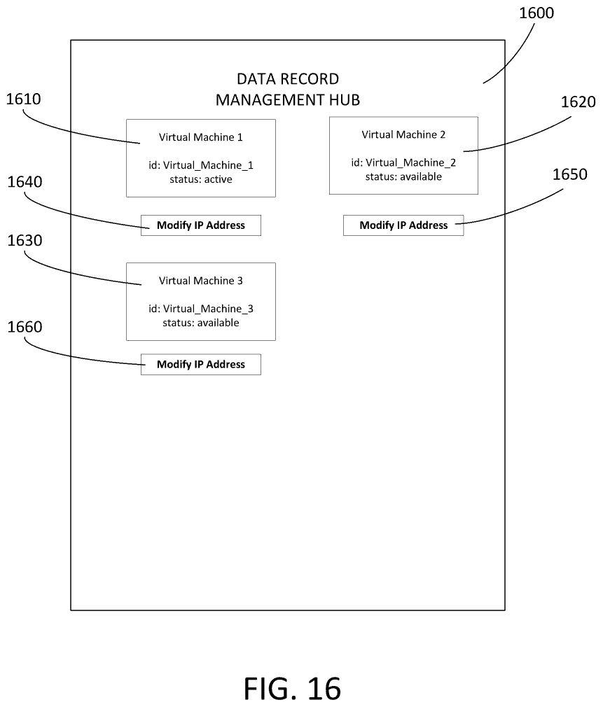

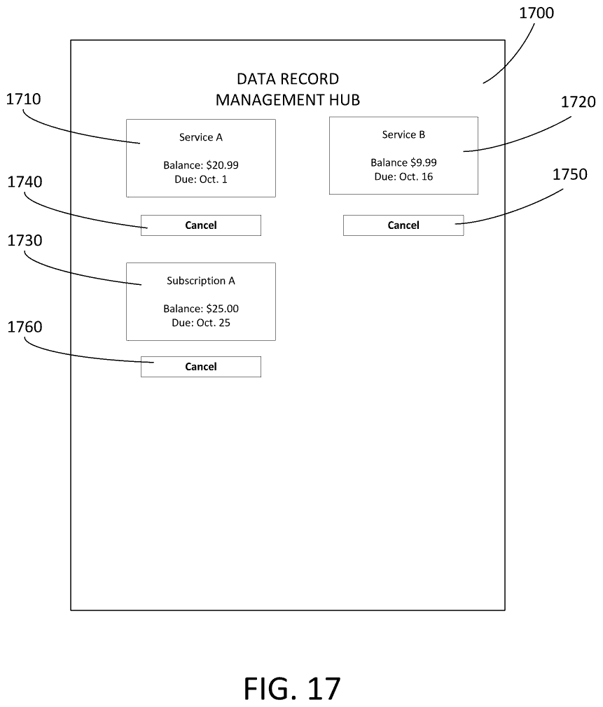

In accordance with embodiments described herein, the server computer system 120 may be utilized to generate recommendations in response to a request to modify an IP address of one or more virtual machines. The recommendation may be presented when it is determined that the one or more virtual machines are currently being accessed or one or more other conditions that may result in an error. For example, changing the IP address of a virtual machine that is actively communicating with one or more other systems may cause an immediate disconnection from the network. This may disrupt ongoing processes like data transfers, API calls, or active sessions. As such, the recommendations may be generated in an attempt to minimize disruption of active connections to the virtual machine. For example, the recommendation may include a recommendation to modify the IP address of another virtual machine that is not currently being accessed. In this embodiment, the data record management interface described herein may be configured to display only data records associated with virtual machines and the selectable interface elements described herein may be modified to display more specific details regarding the requested modification. An example interface 1600 is shown in FIG. 16. As can be seen, the example interface 1600 includes graphic elements 1610, 1620, 1630 each of which is associated with a data record for a particular virtual machine and selectable interface elements 1640, 1650, 1660 for modifying an IP address of the associated virtual machine.

In accordance with embodiments described herein, the server computer system 120 may be utilized to generate recommendations or offers to a user in response to a request to cancel a service or subscription offered by a third party. The recommendations or offers may be presented to offer an alternative service or subscription and/or to incentivize the user to keep the service or subscription by offering a reduced price or by offering an incentive such as loyalty points. The recommendations may be generated at the request of a provider of the service, the provider of the alternative service, or by the server computer system 120. In this embodiment, the data record management interface described herein may be configured to display only data records associated with services or subscriptions and the selectable interface elements described herein may be modified to display more specific details regarding the requested modification. An example interface 1700 is shown in FIG. 16. As can be seen, the example interface 1700 includes graphic elements 1710, 1720, 1730 each of which is associated with a data record for a particular service or subscription and selectable interface elements 1740, 1750, 1760 for cancelling the associated service or subscription. In this example, each selectable interface element may include a deep link embedded therein that causes the computing device to navigate to a web page for requesting the cancellation in response to selection thereof. The web page may be a web page associated with the service or subscription maintained by the third party server.

As mentioned, the server computer system 120 may utilize or engage a machine learning module that is trained to identify the at least one alternative modification. It will be appreciated that the server computer system 120 may retrain the machine learning module based on one or more accepted alternative modifications. For example, a new set of training data may be generated based on one or more accepted alternative modifications and this new training data may be used to retrain the machine learning module.

The methods described herein may be modified and/or operations of such methods combined to provide other methods.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the herein discussed embodiments are considered to be illustrative and not restrictive.

What is claimed is:

1. A server computer system comprising:
at least one processor;
a communications module coupled to the at least one processor; and
a memory coupled to the at least one processor, the memory storing instructions that, when executed, configure the at least one processor to:
send, via the communications module to a computing device, a signal that causes the computing device to display a selectable interface element for requesting modification to a data record maintained by a third party server;
receive, via the communications module from the computing device, a signal indicating selection of the selectable interface element;
identify at least one alternative modification based at least on the requested modification; and
send, via the communications module to the computing device, a signal causing the computing device to display a recommendation for the at least one alternative modification.

2. The server computer system of claim 1, wherein the selectable interface element includes a deep link embedded therein that causes the computing device to navigate to a web page for requesting the modification to the data record maintained by the third party server in response to selection thereof.

3. The server computer system of claim 2, wherein the signal causing the computing device to display the recommendation interrupts navigation to the web page.

4. The server computer system of claim 3, wherein the recommendation includes a selectable interface element for rejecting the recommendation and resuming navigation to the web page for requesting the modification to the data record maintained by the third party server.

5. The server computer system of claim 1, wherein the recommendation includes at least one selectable interface element for accepting the recommendation for the at least one alternative modification.

6. The server computer system of claim 5, wherein the instructions, when executed, configure the at least one processor to:
receive, via the communications module from the computing device, a signal indicating selection of the at least one selectable interface element for accepting the at least one alternative modification; and
perform one or more operations to complete the accepted the at least one alternative modification.

7. The server computer system of claim 1, wherein the at least one alternative modification includes modification to at least one of the data records maintained by the third party server, at least one other data record, or creating at least one other data record.

8. The server computer system of claim 1, wherein the at least one alternative modification includes at least one alternative modification that requires less resources than the modification to the data record maintained by the third party server.

9. The server computer system of claim 1, wherein when identifying the at least one alternative modification, the instructions, when executed, configure the at least one processor to:
engage a machine learning module trained to identify the at least one alternative modification.

10. The server computer system of claim 9, wherein the instructions, when executed, configure the at least one processor to:
receive, via the communications module from the computing device, a signal indicating selection of a selectable interface element for accepting the at least one alternative modification; and
re-train the machine learning module at least based on the accepted at least one alternative modification.

11. A computer-implemented method comprising:
sending, via a communications module to a computing device, a signal that causes the computing device to display a selectable interface element for requesting modification to a data record maintained by a third party server;
receiving, via the communications module from the computing device, a signal indicating selection of the selectable interface element;
identifying at least one alternative modification based at least on the requested modification; and
sending, via the communications module to the computing device, a signal causing the computing device to display a recommendation for the at least one alternative modification.

12. The computer-implemented method of claim 11, wherein the selectable interface element includes a deep link embedded therein that causes the computing device to navigate to a web page for requesting the modification to the data record maintained by the third party server in response to selection thereof.

13. The computer-implemented method of claim 12, wherein the signal causing the computing device to display the recommendation interrupts navigation to the web page.

14. The computer-implemented method of claim 13, wherein the recommendation includes a selectable interface element for rejecting the recommendation and resuming navigation to the web page for requesting the modification to the data record maintained by the third party server.

15. The computer-implemented method of claim 11, wherein the recommendation includes at least one selectable interface element for accepting the recommendation for the at least one alternative modification.

16. The computer-implemented method of claim 15, further comprising:
receiving, via the communications module from the computing device, a signal indicating selection of the at least one selectable interface element for accepting the at least one alternative modification; and
performing one or more operations to complete the accepted the at least one alternative modification.

17. The computer-implemented method of claim 11, wherein the at least one alternative modification includes modification to at least one of the data records maintained by the third party server, at least one other data record, or creating at least one other data record.

18. The computer-implemented method of claim 11, wherein the at least one alternative modification includes at least one alternative modification that requires less resources than the modification to the data record maintained by the third party server.

19. The computer-implemented method of claim 11, wherein when identifying the at least one alternative modification, the method further comprises:
engaging a machine learning module trained to identify the at least one alternative modification;
receiving, via the communications module from the computing device, a signal indicating selection of at least one selectable interface element for accepting the at least one alternative modification; and
re-training the machine learning module at least based on the accepted at least one alternative modification.

20. A non-transitory computer readable storage medium comprising processor-executable instructions which, when executed, configure at least one processor to:
send, via a communications module to a computing device, a signal that causes the computing device to display a selectable interface element for requesting modification to a data record maintained by a third party server;
receive, via the communications module from the computing device, a signal indicating selection of the selectable interface element;
identify at least one alternative modification based at least on the requested modification; and
send, via the communications module to the computing device, a signal causing the computing device to display a recommendation for the at least one alternative modification.
